(19) United States
(12) Patent Application Publication
(10) Pub. No.: US 2009/0003348 A1
(43) Pub. Date: Jan. 1, 2009

(54) IP aggregation with blackhole entry

(76) Inventors: Nagalingswami Kulkarni, Bangalore (IN); K.J. Viswanath, Bangalore (IN); Sanjay Kuhikar, Bangalore (IN)

Correspondence Address: HARNESS, DICKEY & PIERCE, P.L.C., P.O. BOX 8910, RESTON, VA, 20195, US

(21) Appl. No.: 11/819,971

(22) Filed: Jun. 29, 2007

(51) Int. Cl. H04L 12/56

(52) U.S. Cl. 370/392

(57) ABSTRACT

Provided is a method of route aggregation in a communication system. The method includes receiving an advertised aggregated network routes from a first router, the advertised aggregated network route including at least one blackhole subnetwork route, and updating a forwarding information base (FIB) to include the at least one blackhole route.

### BACKGROUND OF THE INVENTION

IP addresses are generally 32 bit integers, which identify a network entity in an IP domain. Routers in the IP domain use these IP addresses to route packets. To properly route the packets, the routers maintain a forwarding table having route entries suggesting an outgoing interface and the next-hop of the packet. In a typical Internet Support Provider (ISP) environment, the forwarding table often runs into millions of entries.

To reduce the size of the routing tables, a route aggregation method may be used. Route aggregation summarizes routes to reduce the number of advertisements across the Internet. An advertisement may be considered as information passed from one router to another router. The information may contain the best route, to send for example, data, to a final destination. Route aggregation also routes smaller prefixes by an aggregated larger prefix known as “supernetting.”

FIG. 1 illustrates conventional routing. Assume that a first internet service provider (ISP1) (or router 1 (RTR1) is advertising 161.1/16 network addresses by providing services to all the 24 bit prefix subnetworks, for example, 161.1.0/24 to 161.1.255/24 contained within this network. This enables ISP1 connected to a second internet service provider (ISP2) (or router 2 (RTR2) by a link L12 to advertise aggregated network 161.1/16 based on which traffic for these networks may be routed from ISP2. The link L12 may be a data link such as a T1 line, T3 line, Ethernet connection, wireless connection, etc. Further assume that 24 bit prefix subnetwork, 161.1.1.0/24, is an unreachable route. For example, the 161.1.1/24 subnetwork may be down for maintenance and thus unreachable. Then ISP1 has two choices:
1) Advertise the same aggregated network (161.1/16) and once the traffic for 161.1.1/24 reaches ISP1, drop the traffic. However, this may lead to wasting network bandwidth, a disconnected network, and routing loops. Most of the existing routing protocols, for example, Border Gateway Protocol (BGP) and Routing Information Protocol (RIP) employ this mechanism under an administrative control.
2) De-aggregate the 161.1/16 route entry into multiple 24 bit prefixes and advertise them. However, this may lead to additional forwarding table entries, which may create large overhead on the routers. ISP1 may have to advertise 254 subnetworks with 24 bit prefixes. Since the routing information is advertised across the Internet, the overhead caused by such an advertisement on the routers may be enormous.

### SUMMARY OF THE INVENTION

Example embodiments of the present invention provide a method of route aggregation in a communication system. The method includes receiving advertised aggregated network routes from a first router, the advertised aggregated network routes including at least one blackhole subnetwork route, and updating a forwarding information base (FIB) to include the at least one blackhole subnetwork route.

Example embodiments of the present invention provide a method of route aggregation in a communication system including sending an advertised aggregate network routes to a router, the advertised aggregate network route including at least one blackhole route.

### BRIEF DESCRIPTION OF THE DRAWINGS

Example embodiments of the present invention will become more fully understood from the detailed description given herein below and the accompanying drawings, which are given by way of illustration only and thus are not limiting of the example embodiments of the present invention.

FIG. 1 illustrates a conventional communication system with routers;

FIG. 2 illustrates a communication system with routers of an example embodiment of the present invention;

FIGS. 3A and 3B show flowcharts of methods of route aggregation in a communication system according to an example embodiment of the present invention;

FIG. 4 illustrates a communication system with routers of another example embodiment of the present invention; and

FIG. 5 shows a flowchart of a method of route aggregation in a communication system according to an example embodiment of the present invention.

FIGS. 6A and 6B show flowcharts of method of route aggregation in a communication system according to an example embodiment of the present invention.

### DETAILED DESCRIPTION OF EXAMPLE EMBODIMENTS

Example embodiments of the present invention as described herein may apply to telecommunication systems including a code division multiple access (CDMA) network, WCDMA, GSM, Universal Mobile Telecommunications System (UMTS), etc. Example embodiments of the present application may also apply to any systems using routers to advertise routing destinations.

In the conventional art, it is generally known that blackhole routes are routes having a nexthop as null, and are used to reduce traffic by dropping the traffic destined to blackhole network. The nexthop generally indicates the next stop or next destination for an advertised route. For example, a route from point A to point D may require stops at points B and/or C. A first router may advertise the nexthop as point B, and a second router may advertise the nexthop as point C. A router will drop traffic destined for blackhole routes. In other words, a router receiving data for routing will drop the traffic for an unreachable subnetwork.

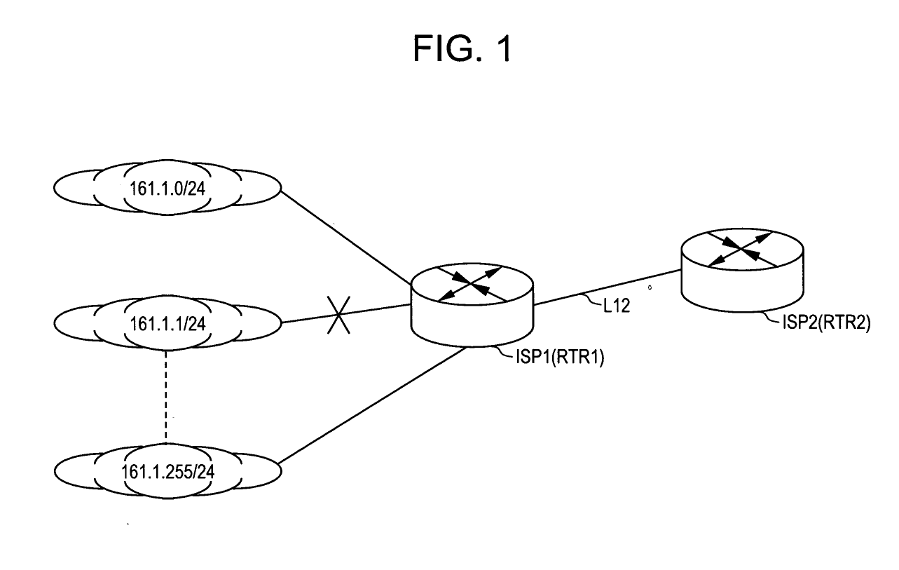

With reference to FIG. 1, if 161.1.1/24 is a blackhole route, the information that 161.1.1/24 is not available is present only at ISP1. In the conventional art, a system administrator must manually configure the blackhole route at ISP2 to drop the traffic for the 161.1.1/24 subnetwork, or ISP1 may advertise deaggregated routes to ISP2. The former method requires manual intervention, and the later method increases the number of traffic routes exchanged between ISP1 and ISP2. As will be described in greater detail below, embodiments are provided for more effectively managing blackhole routes.

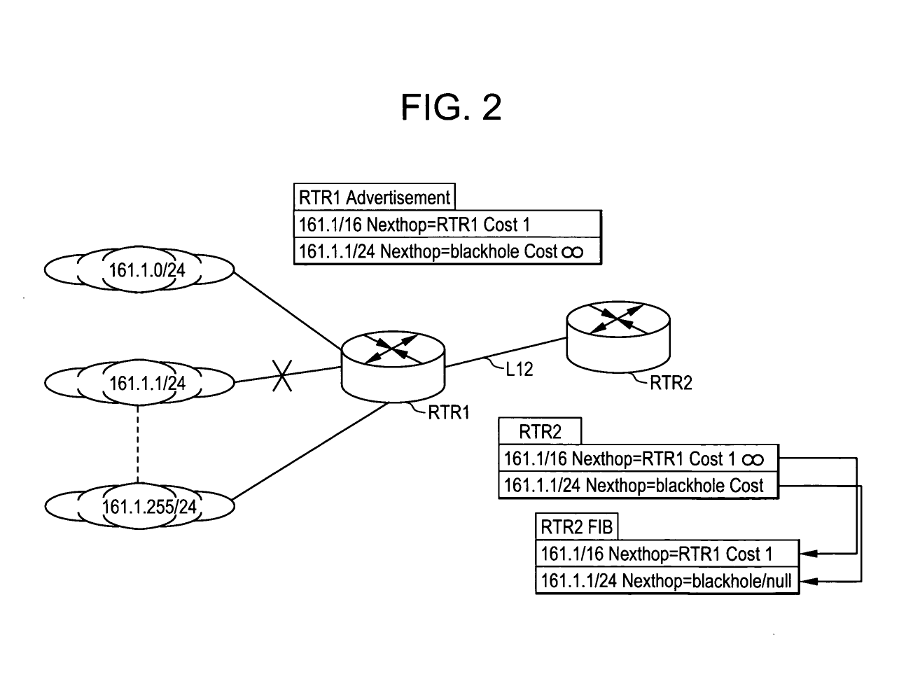

At least one example embodiment will be described with respect to FIG. 2. FIG. 2 illustrates first and second routers RTR1 and RTR2 connected by a link L12 in the same manner as in FIG. 1. The first and second routers RTR1 and RTR2 may each represent internet service providers ISP1 and ISP2, respectively, but it will be understood that example embodiments of the present invention are not limited in application to the routers of internet service providers. The link L12 may be a data link such as a T1 line, T3 line, Ethernet connection, wireless connection, etc.

In example embodiments of the present invention and with reference to FIG. 2, assume that the first router RTR1 is advertising 161.1/16 network addresses by providing services to all the 24 bit prefix subnetworks, for example, 161.1.0/24 to 161.1.255/24 contained within this network. This enables the first router RTR1 to advertise aggregated network 161.1/16 to the second router RTR2 based on which traffic for these networks may be routed from the second router RTR2. Further assume that 24 bit prefix subnetwork, 161.1.1/24, is a blackhole. For example, the subnetwork is down for maintenance.

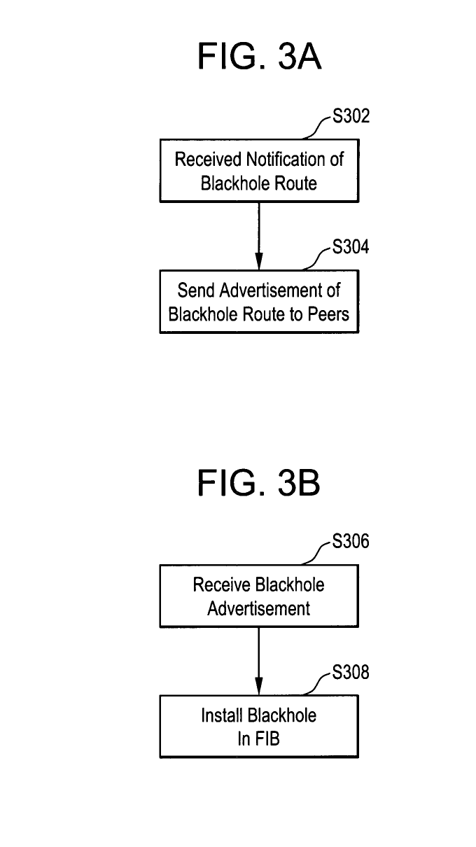

In example embodiments of the present invention, the first router RTR1 advertises null/blackhole (blackhole) routing entries. Accordingly, as shown in the flowchart of FIG. 3A, the first router RTR1 receives notification of the blackhole route in step S302. The notification may be provided by a system administrator, may be detected by the first router RTR1 according to any well-known methodology, etc. Then, in step S304, the first router RTR1 may send advertisements to the second router RTR2 that advertise the 161.1.1/24 blackhole subnetwork. FIG. 2 shows, as repeated in Table 1 below, the first router may send advertisements that: 1) advertise the 161.1/16 network addresses with a nexthop equal to the first router RTR1 and a cost of 1; and 2) advertises the blackhole route 161.1.1/24 as having a nexthop equal to “blackhole” and a cost of infinity. A cost may be associated with a route/interface and configured by an administrator. The lower the cost, the more likely the route/interface is to be used to forward data traffic. As will be appreciated, multiple advertisements subwork 161.1.1/24 may be made, and a multiple advertisements example will be given below. As will be further appreciated, in practice, the nexthop for a blackhole route may be set equal to an agreed upon indicator that represents the nexthop is a blackhole route.

TABLE 1

| Destination N/w | Nexthop | Cost |
|---|---|---|
| 161.1/16 | RTR1 | 1 |
| 161.1.1/24 | Null/Blackhole | ∞ |

As illustrated in the flowchart of FIG. 3B and illustrated in FIG. 2, the second router RTR2 receives the advertisement from the first router RTR1 in step S306. The second router RTR2 installs the blackhole route in its forwarding information base (FIB) in step S308. It will be appreciated that the second router RTR2 would also install this 161.1/16 advertisement in its FIB. Namely, the second router RTR2 may update its forwarding information database to indicate that for routing addresses 161.1/16 the nexthop is the first router RTR1 having a cost equal to 1 and for the subnetwork address 161.1.1/24, the nexthop is a blackhole/null having a cost equal to infinity.

RFC 1812 (Requirements for IP Version 4 Routers) compliant routers use the longest prefix match criteria. Therefore, if a blackhole advertisement has been installed the compliant second router RTR2 having a packet destined for a 161.1.1/24 subnetwork will hit on the second entry and drop the traffic. Namely, the second router RTR2 will recognize that 161.1.1/24 is an non-routable entry, and the second router RTR2 may drop packets destined for this subnetwork. Accordingly, it will be appreciated, that advertising blackhole routes according to embodiments of the present invention, may reduce traffic between routers and provide for greater bandwidth.

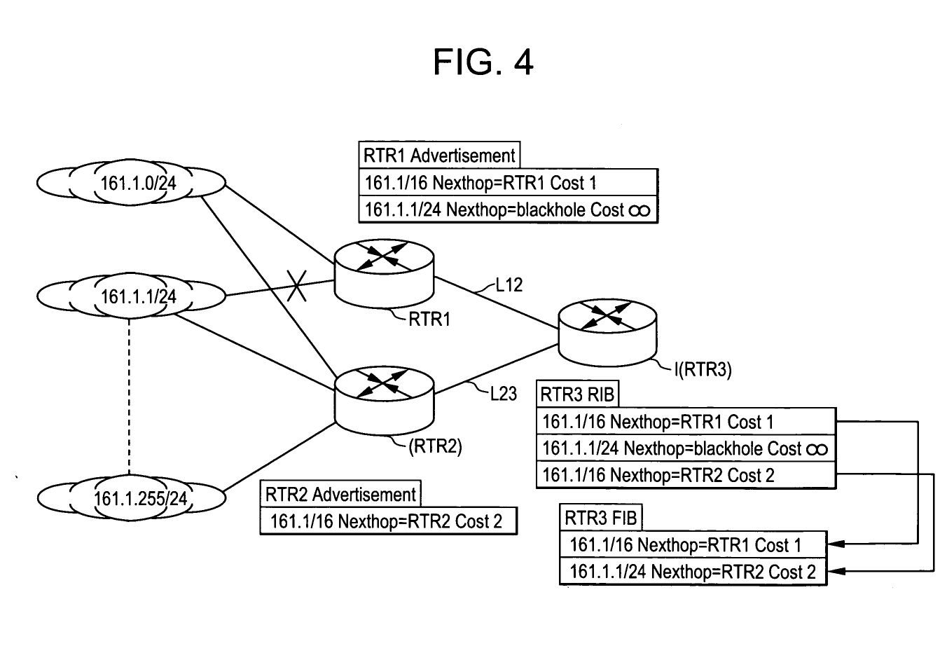

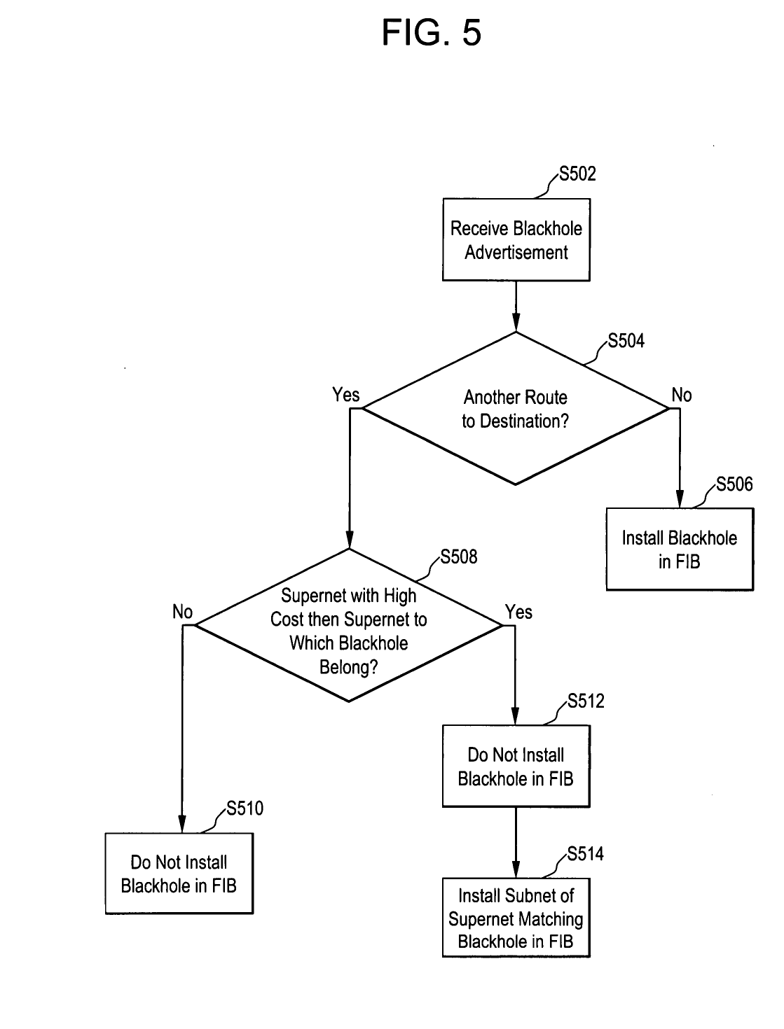

In another example embodiment as illustrated in the flowchart of FIG. 4 and FIG. 5, an alternative route may be advertised (previously or concurrently) for the blackhole route. The alternative route may be advertised by another router.

With reference to FIGS. 4 and 5, three routers, a first router RTR1, a second router RTR2 and a third router RTR3 are illustrated. The first router RTR1 and the second router RTR2 are connected to 161.1.0/24 to 161.255.0/24 subnetworks, and the first router RTR1 is connected by link L12 to the third router RTR3 with a cost=1 and the second router RTR2 is connected by a link L23 to the third router RTR3.

As shown in the flowchart of FIG. 5, the first router RTR1 receives notification of the blackhole route in step S502. The notification may be provided by a system administrator, may be detected by the first router RTR1 according to any well-known methodology, etc. Then, in step S304, the first router RTR1 may send advertisements to the third router RTR3 that advertise the 161.1.1/24 blackhole subnetwork. FIG. 4 shows the first router RTR1 may send advertisements that: 1) advertise the 161.1/16 network addresses with a nexthop equal to the first router RTR1 and a cost of 1; and 2) advertises the blackhole route 161.1.1/24 as having a nexthop equal to “blackhole” and a cost of infinity. As illustrated in FIG. 4, the second router RTR 2 may also advertise the 161.1/16 route entry with a nexthop equal to the second RTR2 and a cost of 2.

If another route to the destination does exist, e.g., advertisement of an alternative route to destination has not been received, as determined in step S504, then in step S508, the third router RTR3 determines if the other route is a supernet or aggregate route with a higher cost than the supernet or aggregate to which the blackhole route belongs. If not, then in step S510 the third router RTR3 does not install the blackhole route in its FIB. It will be appreciated that if a lower cost route exists for the advertised 161.1/16 network addresses, the second router RTR2 would not install this advertisement either.

If, however, the third router RTR3 determines that the other route is a supernet or aggregate route with a higher cost than the supernet or aggregate to which the blackhole route belongs, then in step S512 the third router RTR3 does not install the blackhole route. And, in step S514, the third router RTR3 installs the subnetwork of the higher cost supernet matching the blackhole route in its FIB. It will be appreciated that if a higher cost aggregate route exists for the advertised 161.1/16 network addresses, the second router RTR2 would install this 161.1/16 advertisement in its FIB, as illustrated in Tables 2 and 3:

TABLE 2

| Destination N/w | Nexthop | Cost |
|---|---|---|
| 161.1/16 | RTR1 | 1 |
| 161.1.1/24 | Null/Blackhole | ∞ |
| 161.1/16 | RTR2 | 2 |

TABLE 3

| Destination N/w | Nexthop | Cost |
|---|---|---|
| 161.1/16 | RTR1 | 1 |
| 161.1.1/24 | RTR2 | 2 |

A router may replace installed blackhole routes in its forwarding table in the following cases:
1) A router advertises a route, which may be a supernetting (or same) route to the blackhole entry with a higher cost. In such a case, the subnetwork route with a higher cost replaces the blackhole route entry. The supernetting route received from another advertiser is not installed, only the subnetwork of that route which matches the blackhole entry is installed in the FIB.
2) If a router advertises a lower cost entry than both the aggregated routes and blackhole route entries, the route is replaced by the lower cost entry.

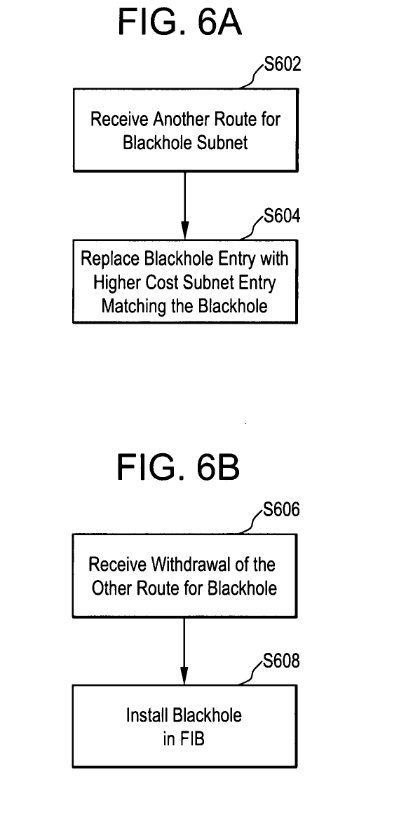

As disclosed above and with reference to the flowchart of FIG. 6A, the third router RTR3 may receive another advertisement even after the blackhole has been entered into the FIB in step S602. The third router RTR 3 will replace the blackhole entry with the higher cost subnetwork entry matching the blackhole entry in the FIB only in step S604. In other words, the blackhole route advertised by the first router RTR1 is replaced in the third router's RTR3 FIB, and the replacement (alternative) route of the second router RTR2 may cause the blackhole entry to be deleted. If a blackhole entry is replaced by a higher cost subnetwork entry, then the blackhole entry is deleted and routes for supernetting are recomputed.

When the blackhole entry advertised from the first router RTR1 is replaced, a re-computation of the FIB entry of the third router RTR3 is triggered, which substitutes the blackhole entry. For example, in the above case, when 161.1.1/24 blackhole entry is replaced, the 161.1.1/24 entry with a nexthop equal to the second router RTR2 should also be deleted from the FIB. The new FIB is illustrated in Table 4:

TABLE 4

| Destination N/w | Nexthop | Cost |
|---|---|---|
| 161.1/16 | RTR1 | 1 |

As shown in the flowchart of FIG. 6B, the third router RTR 3, having installed the entry of the higher cost subnetwork matching the blackhole entry as illustrated in the flowcharts of FIGS. 5 and 6A, may receive a withdrawal of the higher cost subnetwork matching the blackhole entry from the second router RTR2 in step S606. Then, the blackhole route advertised by the first router RTR1 may be reinserted in the FIB of the third router RTR3 in step S608.

When an entry from the second router RTR2 is replaced as illustrated in FIGS. 4 and 6B, then the subnetwork entry present in the FIB of the third router RTR3 is erased and replaced with the blackhole entry of the first router RTR1. The FIB should have pointers to all FIB entries, which are subsets of it and are placed in the FIB because of this entry. The new FIB is illustrated in Table 5:

| Destination N/w | Nexthop | Cost |
|---|---|---|
| 161.1/16 | RTR1 | 1 |
| 161.1.1/24 | Null/Blackhole | ∞ |

In example embodiments of the present invention, the first router RTR1 may run an algorithm to detect at any given time whether it would be beneficial to advertise multiple de-aggregated routes or a single aggregated route with multiple blackhole entries. For example, when a first router RTR1 detects any new subnet is down/up and if the subnet belongs to the aggregated route, then the first router RTR1 checks the number of subnet route for which the aggregate route is advertised that should be greater than the number of blackhole routes to be advertised along with the aggregated route, if this condition is not met then all the blackhole routes are withdrawn and subnetwork routes are advertised. If the benefit is not substantial in reducing the number of routes advertised, then the blackhole entries should be avoided. However, the count of blackhole entries should not increase beyond the de-aggregated route. The balancing ratio may be configurable by an administrator.

Example embodiments of the present invention may provide a reduction in the number of routing entries in the FIB and RIB and reduce the number of computation cycles. Reducing the number of entries in the FIB and RIB may also reduce the use and size of ternary content addressable memory (CAM). In addition, current routing protocols have auto summarization as the default configuration, example embodiments of the present invention may prevent network disconnection and/or routing loops.

What is claimed is:

1. A method of route aggregation in a communication system, comprising:
receiving advertised aggregate network routes from a first router, the advertised aggregate network routes including at least one blackhole subnetwork route; and
updating a forwarding information base (FIB) to include the at least one blackhole route.

2. The method of claim 1, further comprising:
dropping data destined for the blackhole route.

3. The method of claim 1, further comprising:
receiving an advertisement for an alternative route to the blackhole subnetwork route from a second router; and
updating the FIB by replacing the entry of the blackhole subnetwork route with the alternative route.

4. The method of claim 3, wherein the alternative route has a higher cost entry than a cost for both the aggregate network routes and the blackhole route.

5. The method of claim 3, further comprising;
receiving a withdrawal of the at least one blackhole route from the first router; and
updating the FIB by removing the entry of the alternative route.

6. The method of claim 3, further comprising:
receiving a withdrawal of the alternative route from the second router; and
updating the FIB by replacing the entry of the alternative route with the blackhole route.

7. The method of claim 3, wherein the advertisement of the aggregate network routes including the blackhole route and the advertisement for the alternative route are concurrently received.

8. The method of claim 1, further comprising:
updating the FIB including the multiple de-aggregated routes if the benefit of advertising multiple de-aggregated routes is greater than advertising the aggregate network route including the blackhole route.

9. A method of route aggregation in a communication system, comprising:
sending advertised aggregate network routes to a router, the advertised aggregate network routes including at least one blackhole route.

10. The method of claim 9, further comprising:
running an algorithm to detect whether it would be beneficial to advertise multiple de-aggregated routes or a single aggregated route with the blackhole route.

11. The method of claim 9, further comprising:
withdrawing the advertisement of the blackhole route if the benefit of advertising the multiple de-aggregated routes is greater than advertising the aggregate network route including the blackhole route.
